(19) United States
(12) Patent Application Publication
(10) Pub. No.: US 2019/0033492 A1
(43) Pub. Date: Jan. 31, 2019

(54) METHOD FOR GRIPPING A LENS FOR PERFORMING MULTIPLE OPERATIONS

(71) Applicant: Coburn Technologies International, Inc., South Windsor, CT (US)

(72) Inventor: Wolfgang Strobel, Tolland, CT (US)

(21) Appl. No.: 15/664,726

(22) Filed: Jul. 31, 2017

(51) Int. Cl. G02B 1/12; B25B 11/00; B05D 1/00

(52) U.S. Cl. CPC G02B 1/12; B05D 1/005; B25B 11/005

(57) ABSTRACT

A method for performing multiple operations on a lens includes performing a first operation on the lens with the lens secured to a suction device at a first pressure value within the suction device. The method further includes changing pressure within the suction device to a second pressure value different from the first pressure value using a controller and performing a second operation on the lens with the lens secured to the suction device at the second pressure value.

### BACKGROUND

Various operations may be performed on a lens such as an optical lens during its manufacture or final preparation for use. These operations may include applying a coating to the lens and then curing the coating. During such operations, lenses or lens blanks (hereinafter simply referred to as lens) must be manipulated in a controlled manner. For example, in a spin coating operation, lenses are generally secured using vacuum through a suitable suction cup. Due to imbalances in various lenses that will introduce vibrations during spinning (typically about 2000 RPM) a relatively high degree of vacuum is commonly utilized to ensure retention of the lens. Also during such operations there is a commercially relevant number of lenses that experience warpage. This condition heralds rework or discarding of the lens and accordingly increases manufacturing costs. Consequently, alternative methods for conducting operations that avoid warpage would be well received in the art.

### BRIEF SUMMARY

Disclosed is a method for performing multiple operations on a lens. The method includes: performing a first operation on the lens with the lens secured to a suction device at a first pressure value within the suction device; changing pressure within the suction device to a second pressure value different from the first pressure value using a controller; and performing a second operation on the lens with the lens secured to the suction device at the second pressure value.

### BRIEF DESCRIPTION OF THE DRAWINGS

The following descriptions should not be considered limiting in any way. With reference to the accompanying drawings, like elements are numbered alike:

FIG. 1 depicts aspects of a lens having an coating affixed to the lens;

FIG. 2 depicts aspects of a suction device system configured to secure the lens to a suction device;

FIG. 3 depicts aspects of a process having multiple stages; and

FIG. 4 is a flow chart for a method for performing multiple operations on the lens.

### DETAILED DESCRIPTION

A detailed description of one or more embodiments of the disclosed apparatus and method presented herein by way of exemplification and not limitation with reference to the figures.

Lens warpage is, as noted above, a detractor from optical business profitability and accordingly is bemoaned by various businesses whose processes generate statistically significant numbers of warped or otherwise unusable lenses. Disclosed are methods that reduce or eliminate lens warpage or damage during lens processing and thereby will improve profitability numbers for businesses that use the method. It has been determined by the inventor hereof that while industry experts believe latent stresses in lenses are to blame for warpage, a majority of the warpage experienced is due to the vacuum required to secure an imbalanced lens to a processing holder such as a suction device. In view hereof, the inventor has determined that the pressure value used in the processing holder needs to be tied to the actual operation taking place on the lens. For example, where the lens is to experience multiple operations sequentially, the pressure value securing the lens should be changeable for one or more of the operations. More specifically, the pressure in the suction device is to be adjusted to a sufficient pressure value that adequately secures the lens for the operation that is to be performed without causing warping or damage to the lens. The sufficient pressure value is selected based on the operation to be performed and one or more physical characteristics of the lens such as material type, curvature and thickness as non-limiting examples.

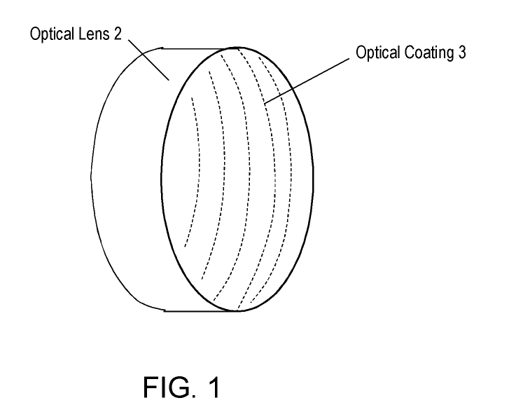

FIG. 1 illustrates one example of a product produced by the methods disclosed below. In FIG. 1, a lens 2 covered with a coating 3 affixed to the lens 2 is illustrated. The lens 2 may be used for any of several applications such for vision correction in eyeglass frames in a non-limiting embodiment. The coating 3 in non-limiting embodiments is configured to improve scratch resistance, limit reflections, and/or reduce light transmission in a specified range of wavelengths.

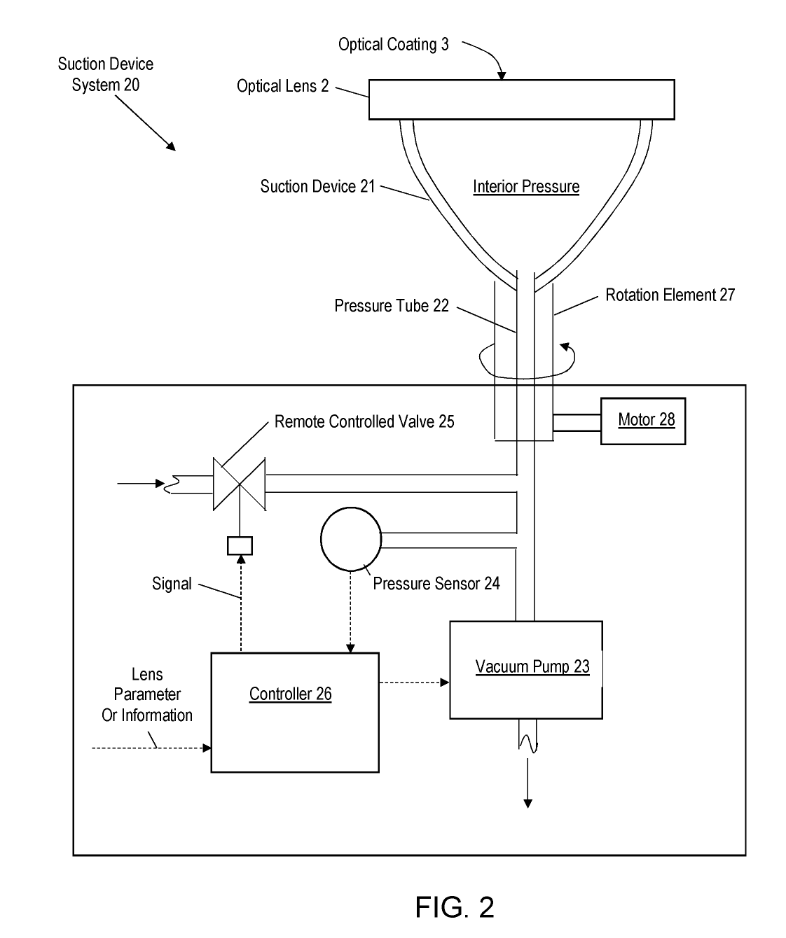

FIG. 2 depicts aspects of a suction device system 20 configured to secure the lens 2 to a suction device 21 for processing the lens 2 in one or more operations. In one or more embodiments, at least a portion of the suction device 21 that is in contact with the lens 2 is made of a pliable material, such as rubber, silicone or a polymer, with a geometry that can conform to at least a portion of a surface of the lens 2. An interior of the suction device 21 is in pressure communication with a pressure tube 22 that is configured to increase and/or decrease pressure of a gas such as air within the interior of the suction device 21. A vacuum pump 23 is configured to remove the gas from the interior of the suction device 21 via the pressure tube 22 and thus decrease the pressure in the interior of the suction device 21. By reducing the interior pressure, the atmospheric pressure provides a holding force that secures the lens 2 to the suction device 21. A pressure sensor 24 is configured to sense pressure in the interior of the suction device 21. A controlled valve 25, such as a remote controlled valve, is configured to open and/or close a pathway from the suction device interior to the atmosphere upon receiving a signal. A controller 26 is configured to control, regulate, and/or adjust the pressure in the interior of the suction device 21 by receiving a pressure signal from the pressure sensor 24 and controlling the vacuum pump 23 and the controlled valve 25. Non-limiting embodiments of the controller 26 include an analog controller, a digital controller, and a switch. The switch may be controlled automatically and/or manually. The controller 26 may be configured to provide automatic control by implementing an automatic control scheme or to accept a manual input from a user. For example, in one or more embodiments the controller 26 may automatically operate the switch in order to control devices that control the pressure in the interior of the suction device 21. Alternatively, in one or more embodiments a user may manually operate the switch in order to control devices that control the pressure in the interior of the suction device 21. In one or more embodiments, the controller 26 implements a feedback control loop to set and/or maintain a desired pressure value within the interior where the set pressure value corresponds to a value of the holding force being applied to the lens 2.

In one or more embodiments, the suction device system 20 may also be configured to spin the lens 2 so that an applied coating can be uniformly distributed over a surface of the lens 2 and excess coating material removed. In this case, the set pressure value of the interior of the suction device 21 is selected to be low enough so that the holding force of the atmospheric pressure is high enough secure the lens 2 in place while the lens 2 is being spun at a selected rotational speed. Hence, the set pressure value is generally dependent on the size, geometry, material property (e.g., density and/or material strength) of the lens 2, and rotational speed. Other factors may also provide input for selecting the set pressure value. For spinning the lens 2, the system 20 may include a motor 28 configured to rotate a rotation element 27 that is coupled to the suction device 21 so that the suction device 21 and lens 2 will spin as the rotation element 27 rotates.

The set pressure value for each type of operation to be performed on the lens 2 may be determined by (1) analysis of each specific lens (or similar lens) to be secured, (2) previous testing of each specific type of lens (or similar lens) to be secured, or (3) a combination of analysis and testing.

The controller 26 may be configured to receive or access the set pressure value for each type of operation to be performed on the lens 2 or the controller 26 may include a processing system configured to determine the set pressure value. To determine the set pressure value, the controller 26 may receive information describing the lens. Using the information, the controller 26 may implement a look-up table that associates the lens information and type of operation to be performed with the appropriate set pressure value. Alternatively or in combination with the look-up table, the controller 26 may be configured to calculate the set pressure value based on the parameters of the type of operation to be performed (e.g., temperature and/or forces) and lens information (e.g., geometry, material strength, material density, and/or others). In one or more embodiments, the calculation is made based on a finite element model of the lens 2 having forces due to the operation of interest being imposed on the finite-element model.

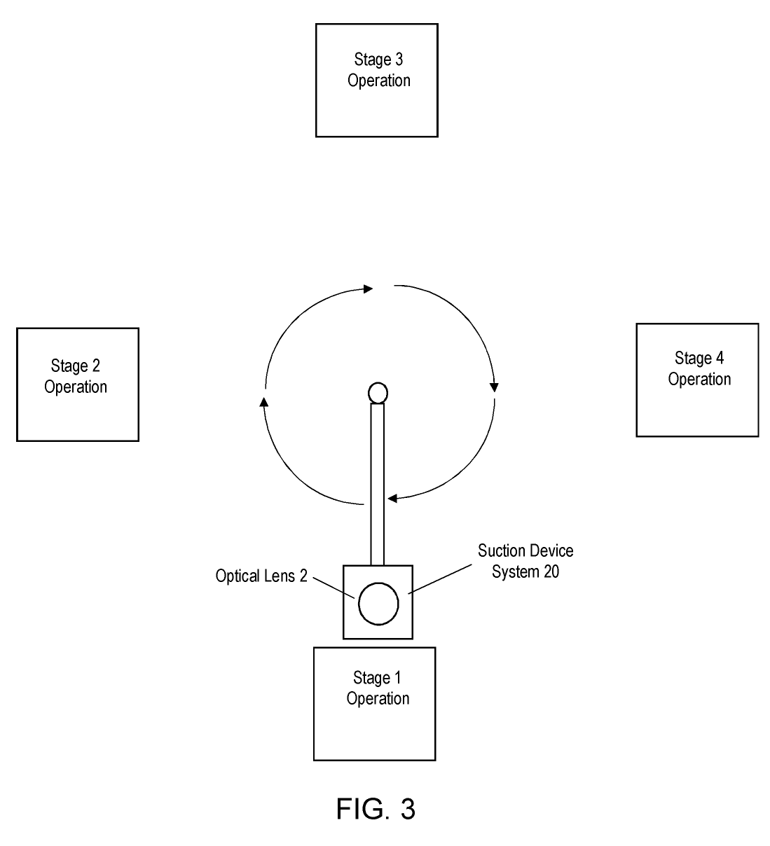

FIG. 3 depicts aspects of a process 30 having multiple stages representing operations. In a non-limiting example, a first stage 31 may include an operation to dispose an amount of the coating 3 material on the lens 2. At this stage, the coating 3 is not permanently affixed to the lens 2. A first set pressure value may be set in the suction device 21 at an adequate level to keep the lens secured while the coating 3 is applied. A second stage may include an operation to spin the lens 2 at a selected rotational speed for a selected amount of time to evenly distribute the coating 3 material in loose form and remove excess coating material. A second set pressure value may be set in the suction device 21 at an adequate level to keep the lens 2 secured while it is being spun. A third stage may include an operation to cure the coating 3 after the lens 2 has been spun. Non-limiting embodiments of the curing operation include curing with ultraviolet light and curing with elevated temperature. Both of these embodiments result in raising the temperature of the lens 2. At these elevated temperatures, the lens 2 may be prone to warping, deforming, or some type of damage if the set pressure value is too low resulting in the securing force (i.e., suction force) being too high for the curing process. Hence, at the third stage the third set pressure value may be increased to above the second set pressure value in order to decrease the securing force applied to the lens 2 and thus reduce the likelihood of warping, deforming or damaging the lens 2. A fourth stage is depicted to represent any other operations that may be performed on the lens 2 at a fourth set pressure that is appropriate the any of the other operations. Although the multiple stages are depicted in a rotary scheme, these stages may also be disposed linearly in an alternative embodiment. It can be appreciated that various operation parameters related to the operations performed on the lens 2 (excluding the securing of the lens with changeable vacuum force) are known in the art and are not discussed in further detail.

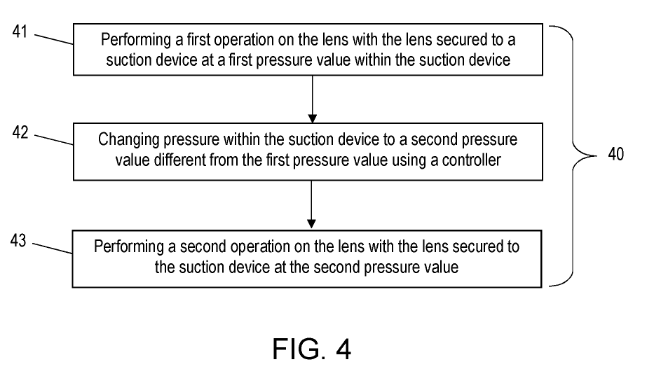

FIG. 4 is a flow chart for a method 40 for performing multiple operations on a lens. Block 41 calls for performing a first operation on the lens with the lens secured to a suction device at a first pressure value within the suction device. In one or more embodiments, the first operation involves spinning the lens at a selected rotational speed for a selected amount of time with the interior pressure of the suction device at a first pressure value that secures the lens firmly to the suction device with adequate force that prevents the lens leaving the suction device due to rotational forces. In one or more embodiments, this block may include operating a vacuum pump in pressure communication with an interior of the suction device. Block 42 calls for changing pressure within the suction device to a second pressure value different from the first pressure value using a controller. In one or more embodiments, changing pressure includes opening a valve in pressure communication with an interior of the suction device. Block 43 calls for performing a second operation on the lens with the lens secured to the suction device at the second pressure value. In one or more embodiments, the second operation involves curing the coating that remains on the lens after the lens is spun resulting in an elevated lens temperature. In one or more embodiments, the second pressure value is greater than the first pressure value resulting in less stress being applied to the lens by the suction device, thus decreasing the likelihood of warping, deforming or damaging the lens.

The method 40 may also include inputting at least one of the first and second pressure values into the controller. The method 40 may also include accessing with the controller (i) lens information comprising at least one of material type and geometry and (ii) determining with the controller at least one of the first and second pressures using the lens information.

The method 40 may also include sensing pressure within the suction device using a pressure sensor and transmitting a signal comprising a sensed pressure value to the controller.

The method 40 may also include sensing a temperature of the lens 2 while it is being gripped using an infrared temperature sensor (not shown) and transmitting the sensed temperature to the controller 26. Using the sensed temperature, the controller 26 can then determine a sufficient pressure value with which to grip the lens 2 to avoid warping, deforming or damaging the lens 2. The controller 26 can determine the sufficient pressure value using a look-up table, by calculation, or some combination thereof.

In support of the teachings herein, various analysis components may be used, including a digital and/or an analog system. For example, the pressure sensor 24 and/or the controller 26 may include digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The terms “first” and “second” are used to differentiate elements and do not denote a particular order.

The flow diagram depicted herein is just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for performing multiple operations on a lens, the method comprising:
performing a first operation on the lens with the lens secured to a suction device at a first pressure value within the suction device;
changing pressure within the suction device to a second pressure value different from the first pressure value using a controller; and
performing a second operation on the lens with the lens secured to the suction device at the second pressure value.

2. The method according to claim 1, wherein the first operation comprises spinning the lens at a selected rotational speed.

3. The method according to claim 2, wherein the second operation comprises curing a coating on the lens.

4. The method according to claim 3, wherein the second pressure value is greater than the first pressure value to provide less vacuum force for the second operation.

5. The method according to claim 1, further comprising inputting at least one of the first and second pressure values into the controller.

6. The method according to claim 1, further comprising accessing with the controller (i) lens information comprising at least one of material type and geometry and (ii) determining with the controller at least one of the first and second pressures using the lens information.

7. The method according to claim 1, wherein changing pressure comprises opening a valve in pressure communication with an interior of the suction device.

8. The method according to claim 1, wherein securing a lens to a suction device comprises operating a vacuum pump in pressure communication with an interior of the suction device.

9. The method according to claim 1, further comprising sensing pressure within the suction device using a pressure sensor and transmitting a signal comprising a sensed pressure value to the controller.

10. The method according to claim 1, further comprising sensing a temperature of the lens and transmitting a signal comprising a sensed temperature value to the controller.
